(19) United States
(12) Patent Application Publication
(10) Pub. No.: US 2016/0227731 A1
(43) Pub. Date: Aug. 11, 2016

(54) PET CAGE

(71) Applicant: Kuo Ho Cheng, Tainan (TW)

(72) Inventor: Kuo Ho Cheng, Tainan (TW)

(21) Appl. No.: 14/616,749

(22) Filed: Feb. 9, 2015

(51) Int. Cl. A01K 1/02; E05C 1/08; E06B 5/00; A01K 1/03

(52) U.S. Cl. CPC A01K 1/0245; A01K 1/03; E05C 1/08; E06B 5/00

(57) ABSTRACT

A pet cage is comprised of a door frame, a lock unit, a top hoard, a bottom board, a left board, a right board, a back board and multiple fasteners. The door frame and the boards are assembled together by multiple fasteners and bolts. The lock unit is included a base on a door which is pivotally connected to the door frame, a receiving base fixed on the door frame, a bar able to resiliently lock the base and the receiving base together, two springs, two pins, and a cover. All of the parts of the pet cage are easy to be dis-assembled piece by piece so that the transportation or storage is saved. The lock unit is operated by one hand to lock or unlock the door.

### BACKGROUND OF THE INVENTION

1. Fields of the Invention

The present invention relates to a pet cage, and more particularly, to a door of a pet cage able to be firmly locked or easily unlocked and easily dis-assembled in case of transportation and storage.

2. Descriptions of Related Art

The conventional pet cage 1 as shown in FIGS. 1 and 2 generally includes a cage 10 which is composed of multiple frames or multiple boards welded together. The conventional pet cage 10 has a door frame 11 at the front side thereof and the door frame 11 has a door 12 which is pivotally connected to the door frame 11. A latch 13 is defined respectively at the upper portion and lower portion of the door 12 in order to lock the door 12 and the door frame 11 together. Each of the latches 13 comprises a first part 130, a second part 131 and a bar 132, wherein the first part 130 fixed to the door frame 11 has first holes 1300, the second part 131 fixed to the door 12 has second holes 1310, and the bar 132 is an L-shaped bar able to extend through the first holes 1300 and second holes 1310 to secure the door 12 to the door frame 11. Nevertheless, the cage 10 is fixed so that space will be occupied while transporting and storing. Besides, the bar 132 is not well secured so that the bar 132 may be pushed to open the door 12 by the pet. In order to open door 12, the bars 132 of the latches 13 will be removed one by one from the first parts 130 and second parts 131. Further, the bars 132 may be dropped from the second holes 1310 of the second part 131 if pushing too hard while opening door 12, and the bars 132 may be lost because of that.

The present invention intends to provide a pet cage to eliminate the shortcomings mentioned above.

### SUMMARY OF THE INVENTION

The present invention relates to a pet cage and comprises a door frame, a lock unit, a top board, a bottom board, a left board, a right board, a back board and multiple fasteners. The door frame has multiple holes. A door has the first side thereof pivotally connected to the first side of the door frame by hinges.

The lock unit is defined on the second side of the door and the second side of the door frame. The lock unit comprises a base, a bar, two springs, two pins, a cover and a receiving base. The base is fixed to the door and has two sliding slots respectively defined on the upper and the lower portion of the base. Two holes are defined respectively at the upper portion and the lower portion of two side walls of the base and correspond to each other. Two engaging slots are respectively defined on the sidewalks of the base and correspond to each other. The bar has two parallel insertion ends and a grip connected between the two insertion ends. The two insertion ends respectively extend through the holes in the two sidewalls of the base. A pin hole is defined respectively on the two insertion ends. The two springs are respectively inserted into the two insertion ends and located between the two sidewalls of the base. The two pins respectively extend through the two pin holes of the two insertion ends and respectively approach to the sliding slot at the upper portion and the lower portion of the base. One end of the two springs is respectively against the inner literal sidewall of the base and the other end of the two springs is respectively abutted to the two pins. The cover has two hooks extending from each of two sides thereof so as to be engaged with the engaging slots of the base to seal the base. The receiving base is fixed on the door frame and its' location is corresponding to the location of the base on the door. The receiving base has two apertures corresponding to the holes of the base.

The top board is connected to the top side of the door frame, and the bottom board is connected to the bottom side of the door frame. Each of the top board and the bottom board has a wall bending from each of four sides thereof. Multiple holes are defined through the wall on the front end of each of the top and bottom boards. Multiple threaded holes are defined through each of the walls on the rear end and two sides of each of the top and bottom boards.

The left board is connected to the left side of the door frame, and the right board is connected to the right side of the door frame. Each of the left board and the right board has a wall bending from each of the front end and the rear end thereof. Multiple holes are defined through the walls on the front end of each of the left and right boards. Multiple threaded holes are defined through each of the walls on the rear end of each of the left and right boards. Multiple holes are defined through the top side and the bottom side of each of the left and right boards. Each of the holes that is defined through the top side and the bottom side of each of the left and right boards has a bolt extending therethrough which is threadedly connected to the threaded hole of each of the walls on the rear and and the two sides of each of the top and bottom boards.

The back board is connected to rear end of each of the top board, the bottom board, the left board and the right board. The back board has multiple holes and each hole of the back board has a bolt extending therethrough which is threadedly connected to the threaded hole of the top board/the bottom board/the left board/the right board.

The multiple fasteners securely extend through holes on the door frame, the top board, the bottom board, the left board and the right board.

Preferably, the bar of the lock unit is a U-shaped bar.

Preferably, each of the insertion ends of the bar has an oblique face defined in the distal end thereof.

Preferably, the receiving base has an oblique plate extending from an outside thereof.

Preferably, each of the fasteners has a reception member and a bolt. The reception member has a tubular portion in which a threaded hole is defined. The bolt is threadedly connected to the threaded hole of the tubular portion.

The primary object of the present invention is to provide a pet cage which can be disassembled into individual parts when being stored and transported.

Another object of the present invention is to provide a pet cage whose lock unit can be operated by one hand, and the bar of the lock unit is well positioned and does not drop.

The present invention will become more obvious from the following description when taken in connection with the accompanying drawings which show, for purposes of illustration only, a preferred embodiment in accordance with the present invention

### BRIEF DESCRIPTION OF THE DRAWINGS

FIG. 1 is a perspective view to show the conventional pet cage;

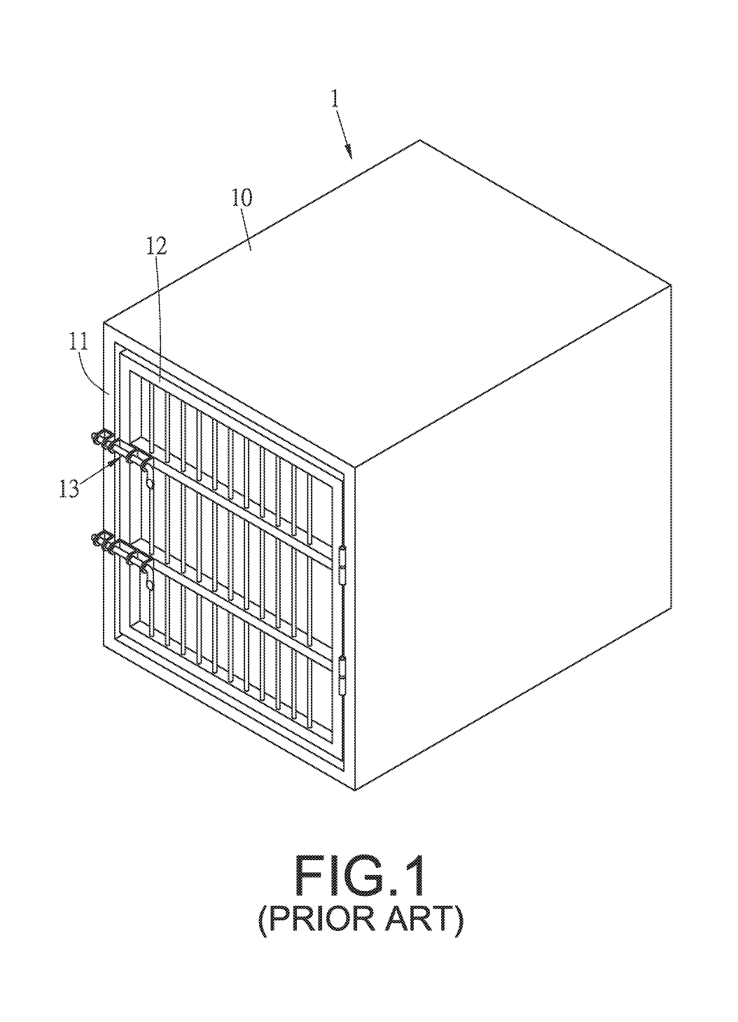

FIG. 2 is an enlarged view to show the locks of the conventional pet cage;

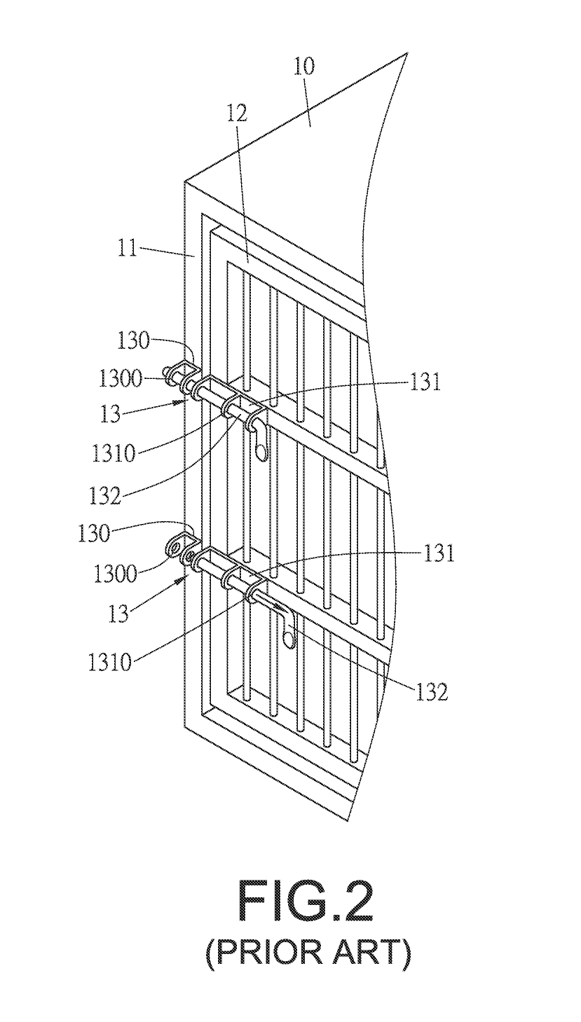

FIG. 3 is an exploded view of the pet cage of the present invention;

FIG. 4 is an exploded view of the lock unit of the pet cage of the present invention;

FIG. 5 is a perspective view to show the lock unit of the pet cage of the present invention;

FIG. 6 is a cross sectional view of the lock unit of the present invention, wherein the bar is in locked position;

FIG. 7 shows a fastener how to secure the door frame and the right board;

FIG. 8 shows the connection of the door from and the top board;

FIG. 9 shows the connection of the top board and the right board;

FIG. 10 shows the connection of the top board and the back board;

FIG. 11 is a perspective view to show the pet cage of the present invention;

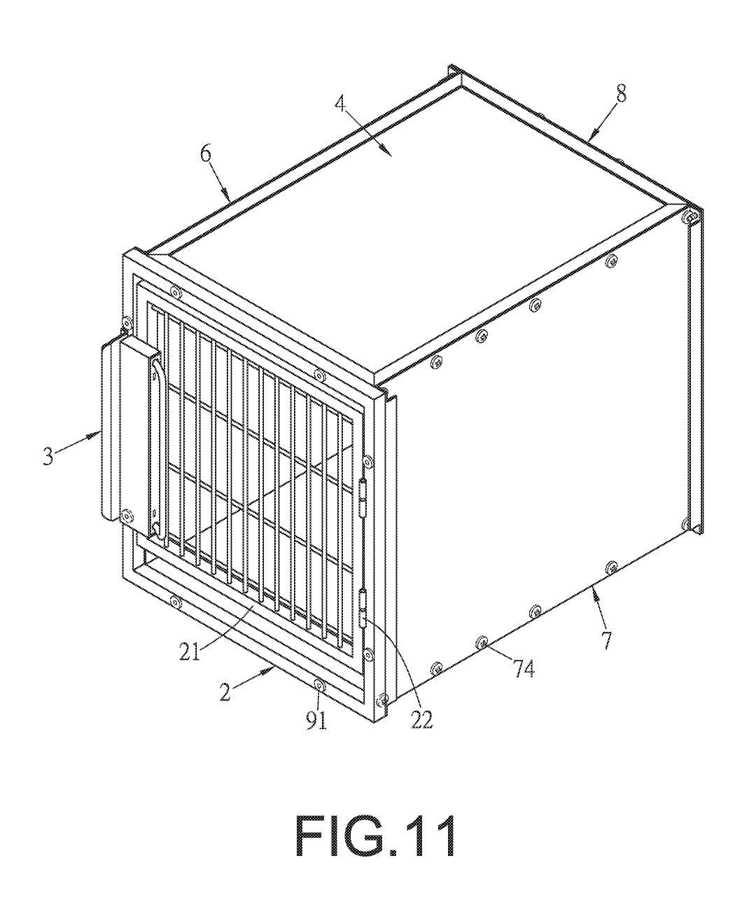

FIG. 12 shows the lock unit on the pet cages of the present invention;

FIG. 13 shows that the lock unit is unlocked and the door is opened;

FIG. 14 shows that the door is closed and the lock unit is locked, and

FIG. 15 shows that the parts of the pet cage are overlapped after dis-assembling.

### DETAILED DESCRIPTION OF THE. PREFERRED EMBODIMENT

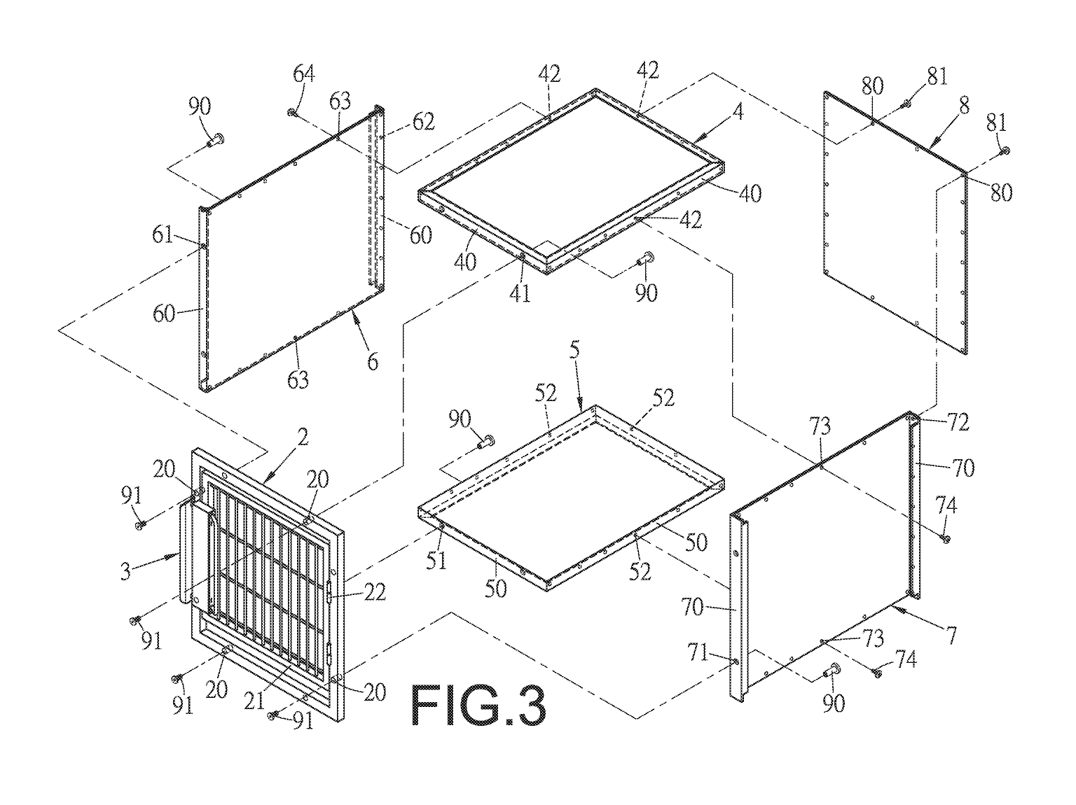

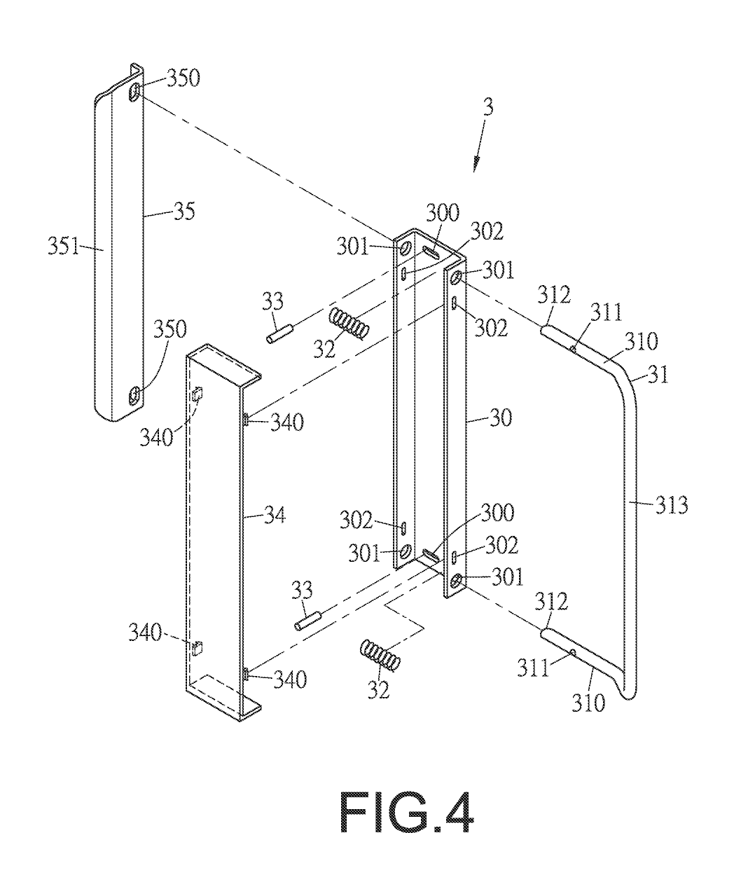

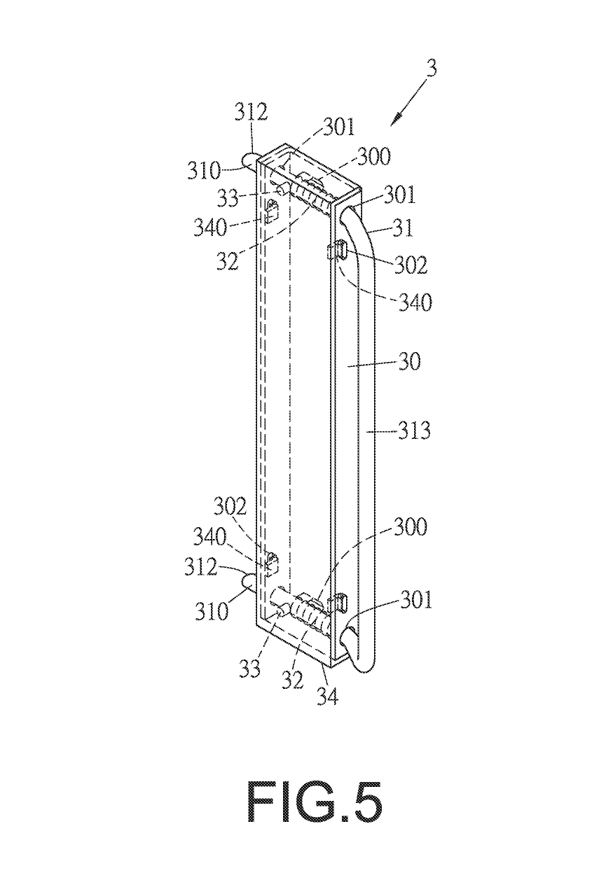

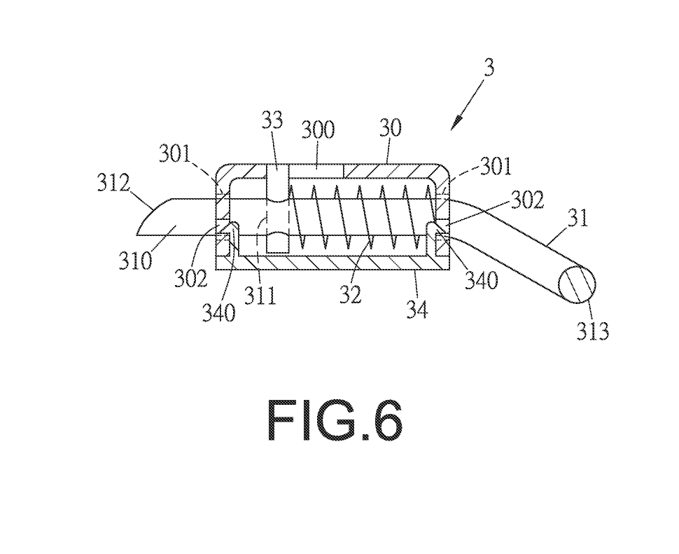

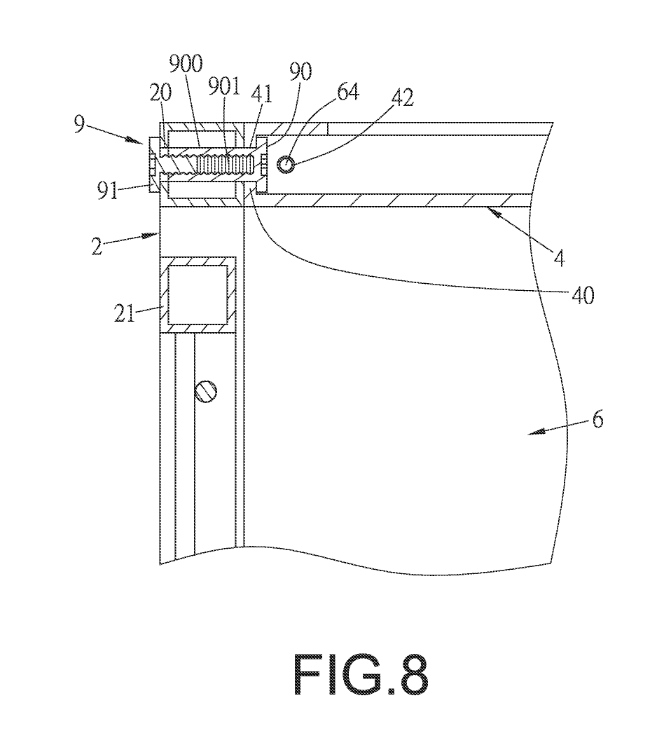

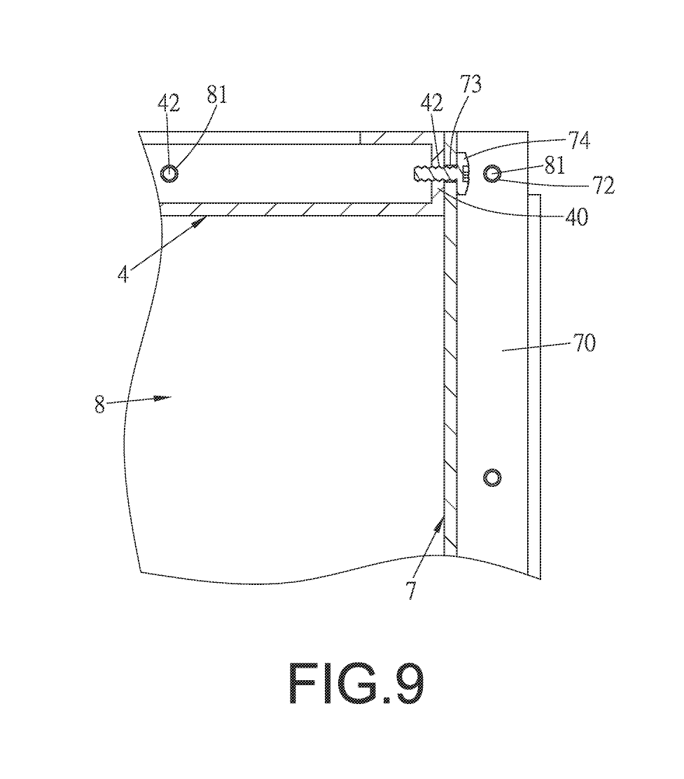

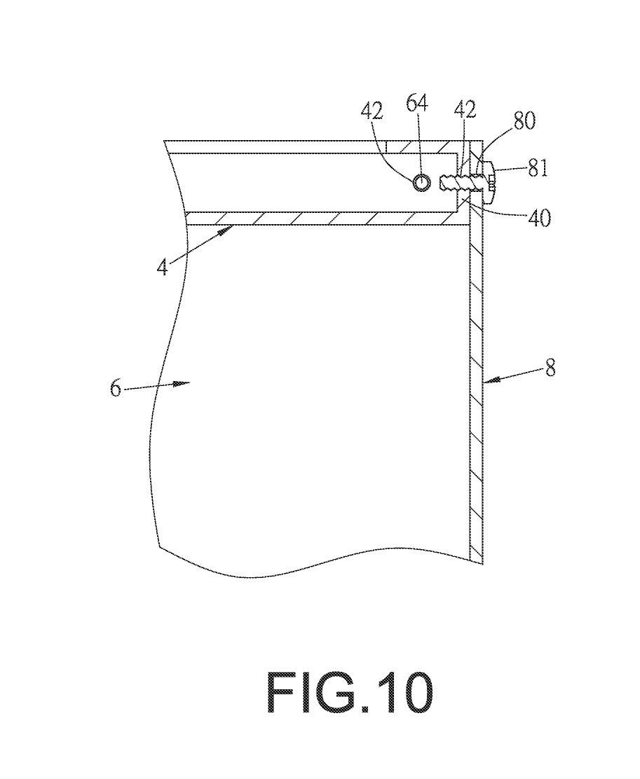

Referring to FIGS. 3 to 10, the pet cage of the present invention comprises a door frame 2, a lock unit 3, a top board 4, a bottom board 5, a left board 6, a right board 7, a back board 8 and multiple fasteners 9. The door frame 2 has multiple holes 20. A door 21 has the first side thereof pivotally connected to the first side of the door frame 2 by two hinges 22.

The lock unit 3 is defined on the second side of the door 21 and the second side of the door frame 2. The lock unit 3 comprises a base 30, a bar 31, two springs 32, two pins 33, a cover 34 and a receiving base 35. The base 30 is fixed to the door 21 and has two sliding slots 300. The base 30 has two sidewalls and each sidewall has two holes 301 and two engaging slots 302. One of the holes 301 and one of the engaging slots 302 are located at an upper position of the base 30, and the other one of the holes 301 and the other one of the engaging slots 302 are located at a lower position of the base 30. The bar 31 is a U-shaped bar and has two parallel insertion ends 310 and a grip 313 is connected between the two insertion ends 310. Each of the insertion ends 310 of the bar 31 has an oblique face 312 defined in the distal end thereof. The two insertion ends 310 respectively extend through the holes 301 in the two sidewalls of the base 30. A pin hole is defined respectively on the two insertion ends. The two springs 32 are respectively inserted into the two insertion ends 310 and located between the two sidewalls of the base 30. The two pins 33 respectively extend through the two pin holes 311 of the two insertion ends 310 and respectively approach to the sliding slot 300 at the upper and the lower portion of the base 3. One end of the two springs 32 is respectively against the inner literal sidewall of the base 3 and the other one end of the two springs is respectively abutted to the two pins 33. The cover 34 has two hooks 340 extending from each of two sides thereof so as to be engaged with the engaging slots 302 of the base 30 to seal the base 30. The receiving base 35 is fixed to the door frame 2 and located corresponding to the base 30 on the door 21. The receiving base 35 has t To apertures 350 which are located corresponding to the holes 301 of the base 30. The receiving base 35 has an oblique plate 351 extending from an outside thereof.

The top board 4 is connected to the top side of the door frame 2, and the bottom board 5 is connected to the bottom side of the door frame 2. Each of the top board 4 and the bottom board 5 has a wall 40/50 bending from each of four sides thereof. Multiple holes 41/51 are defined through the wall on the front end of each of the top and bottom boards 4, 5. Multiple threaded holes 42, 52 are defined through each of the walls on the rear end and two sides of each of the top and bottom boards 4, 5.

The left board 6 is connected to the left side of the door frame 2, and the right board 7 is connected to the right side of the door frame 2. Each of the left board 6 and the right board 7 has a wall 60/70 bending from each of the front end and the rear end thereof. Multiple holes 61/71 are defined through the walls on the front end of each of the left and right boards 6, 7. Multiple threaded holes 62, 72 are defined through each of the walls on the rear end of each of the left and right boards 6, 7. Multiple holes 63/73 are defined through the top side and the bottom side of each of the left and right boards 6, 7. Each of the holes 63/73 that is defined through the top side and the bottom side of each of the left and right boards 6, 7 has a bolt 64/74 extending therethrough which is threadedly connected to the threaded hole 42/52 of each of the walls on the rear end and the two sides of each of the top and bottom boards 4, 5.

The back board 8 is connected to rear end of each of the top board 4, the bottom board 5, the left board 6 and the right board 7. The back board 8 has multiple holes 80 and each hole 80 of the back board 8 has a bolt 81 extending therethrough which is threadedly connected to the threaded hole 42/52/62/72 of the top board 4/the bottom board 5/the left board 6/the right board 7.

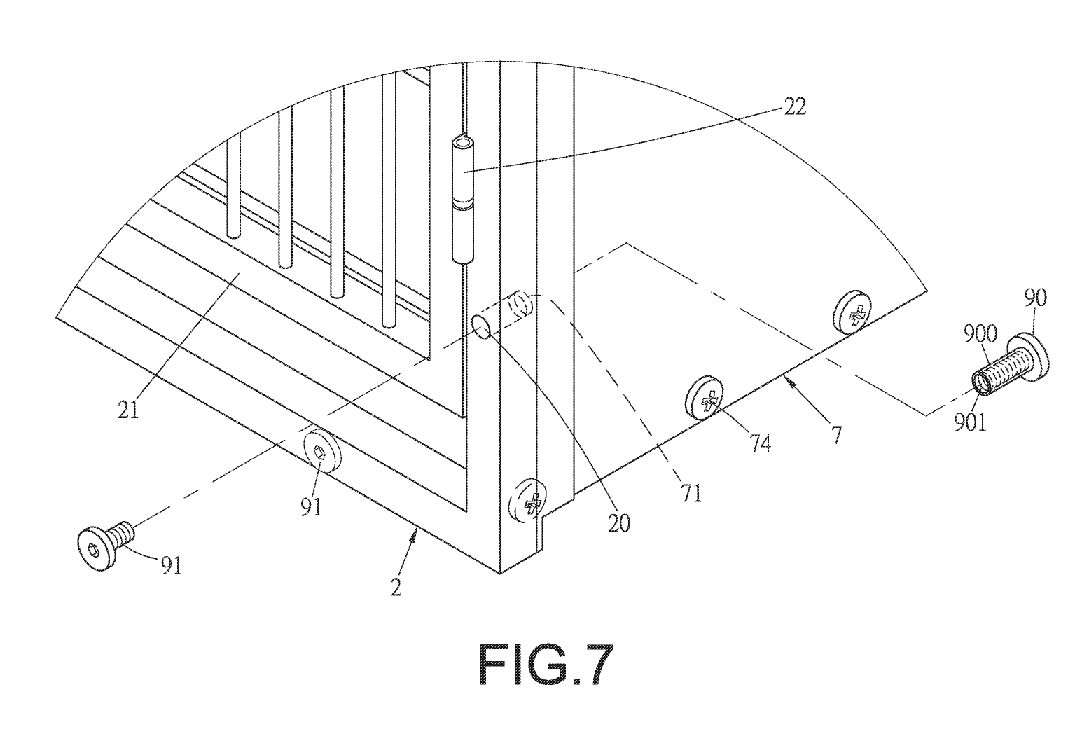

The multiple fasteners 9 securely extend through holes 41, 51, 61, 71 of the door frame 2, the top board 4, the bottom board 5, the left board 6 and the right board 7. As shown in FIGS. 3 and 7, each of the fasteners 9 has a reception member 90 and a bolt 91. The reception member 90 has a tubular portion 900 in which a threaded hole 901 is defined. The bolt 91 is threadedly connected to the threaded hole 901 of the tubular portion 900.

When assembling the pet cage, the two parallel insertion ends 310 extend through the two holes 301 of one of the two sidewalls of the base 30, and the two springs 32 are respectively mounted to the two insertion ends 310. The two pins 33 respectively extend through the two pm holes 311 of the two insertion ends 310. Each pin 33 has one end inserted into the sliding slot 300 corresponding thereto. Each of the springs 32 is biased between the sidewall of the base 30 and the pin 33 corresponding thereto. The distal end of each of the insertion ends 310 extends through the hole 301 from the other sidewalls of the base 30. The cover 34 is then connected to the base 30 by engaging the two hooks 340 of the cover 34 with the engaging slots 302 of the base 30. The grip 313 is located outside of the base 30 which is fixed to the door 21. The receiving base 35 is fixed to the door frame 2. The two insertion ends 310 of the bar 31 respectively extend through the two apertures 350 of the receiving base 35.

The left board 6 and the right board 7 are respectively on two sides of the top board 4 and the bottom board 5. The bolts 64, 74 extend through the holes 63, 73 of the left and right boards 6, 7, and are fixed to the threaded holes 42, of the top board 4 and the bottom board 5. The back board 8 is connected to the rear ends of the top board 4, the bottom board 5, the left board 6 and the right board 7. The bolts 81 extend through the holes 80 of the back board 8 and are threadedly connected to the threaded holes 42, 52, 62, 72 of the top board 4, the bottom board 5, the left board 6 and the right board 7. The door frame 2 is connected to the front and of the top board 4, the bottom board 5, the left board 6 and the right board 7. The tubular portions 900 of the reception members 90 of the fasteners 9 extend through the holes 41, 51, 61, 71 of the walls 40, 50, 60, 70 of the top board 4, the bottom board 5, the left board 6 and the right board 7, and the holes 20 of the door frame 2. The bolts 91 then extend through the holes 20 and are threadedly connected to the threaded holes 901 of the reception members 90. Therefore, the door frame 20 is connected to the top board 4, the bottom board 5, the left board 6 and the right board 7.

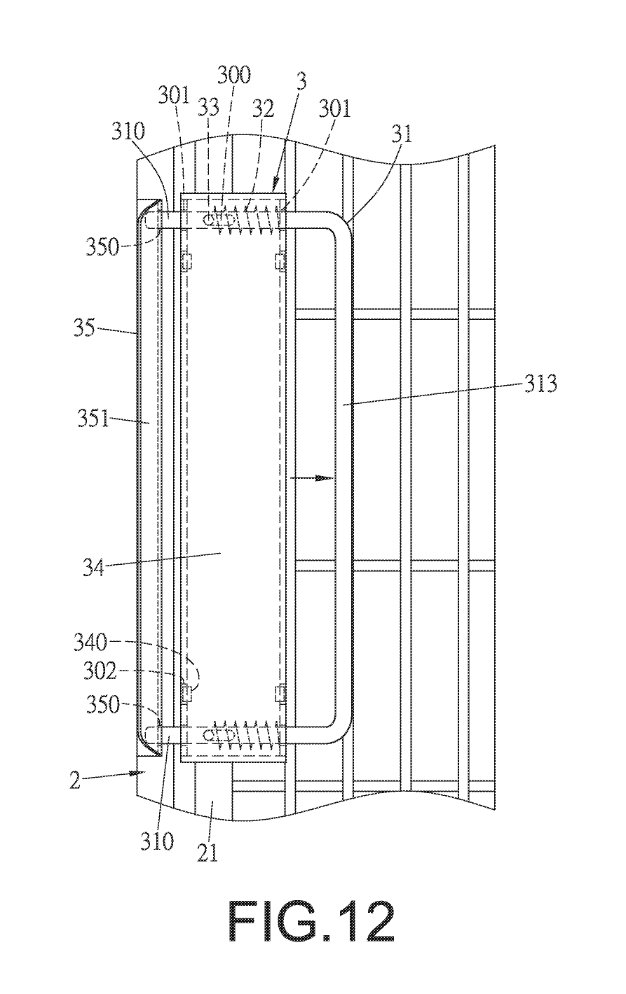

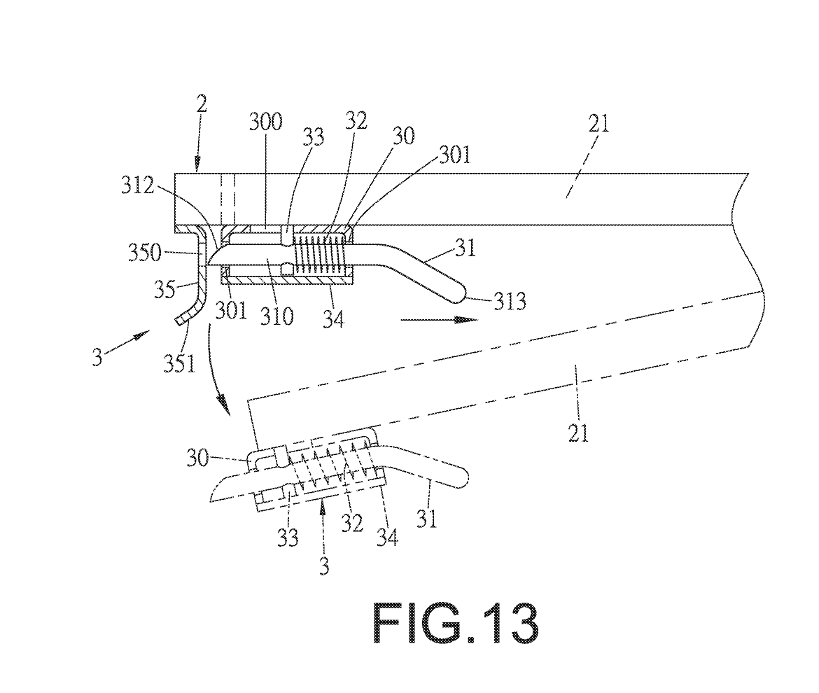

When the door 21 is to be opened, the owner holds the grip 313 and pulls the bar 31 outward as shown in FIGS. 12, 13, the insertion ends 310 compress the springs 32 and the pins 33 are moved within the sliding slots 300, so that the insertion ends 310 are removed from the apertures 350 of the receiving base 35, and the door 21 can be opened. The bar 31 does not drop from the base 30. When releasing; the grip 313, the springs 32 push the two insertion ends 310 back to their initial positions. In other words, the door 21 can be opened by one hand.

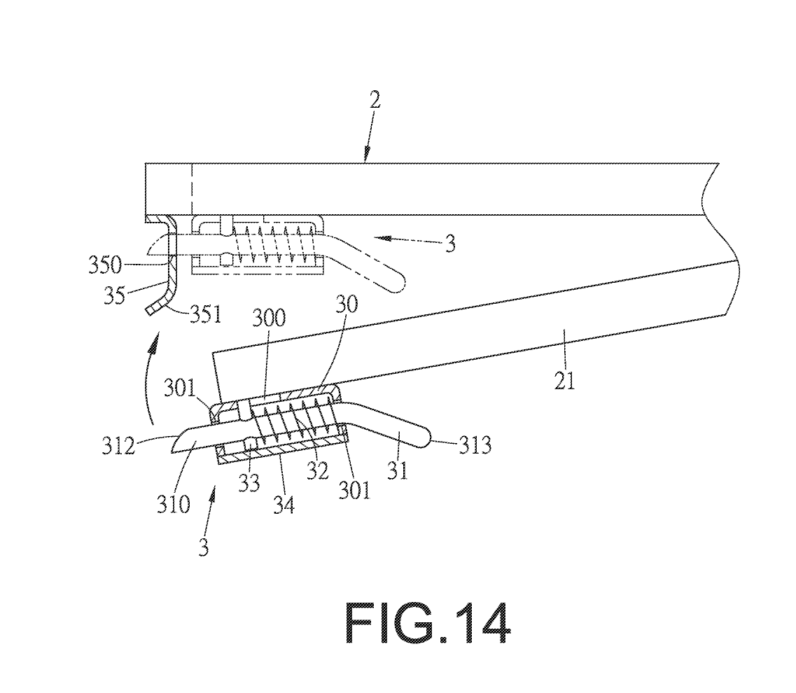

When closing the door 21, the owner pivots the door 21 toward the door frame 2, the two oblique faces 312 of the insertion ends 310 are moved along the tapered plate 351, so that the insertion ends 310 are pushed inward to compress the springs 32 until the two insertion ends 310 are moved to be in alignment with the apertures 350 of the receiving base 35, the springs 32 push the insertion ends 310 are inserted into the apertures 350 again to lock the door 21 as shown in FIG. 14. The door 21 can be closed by one hand.

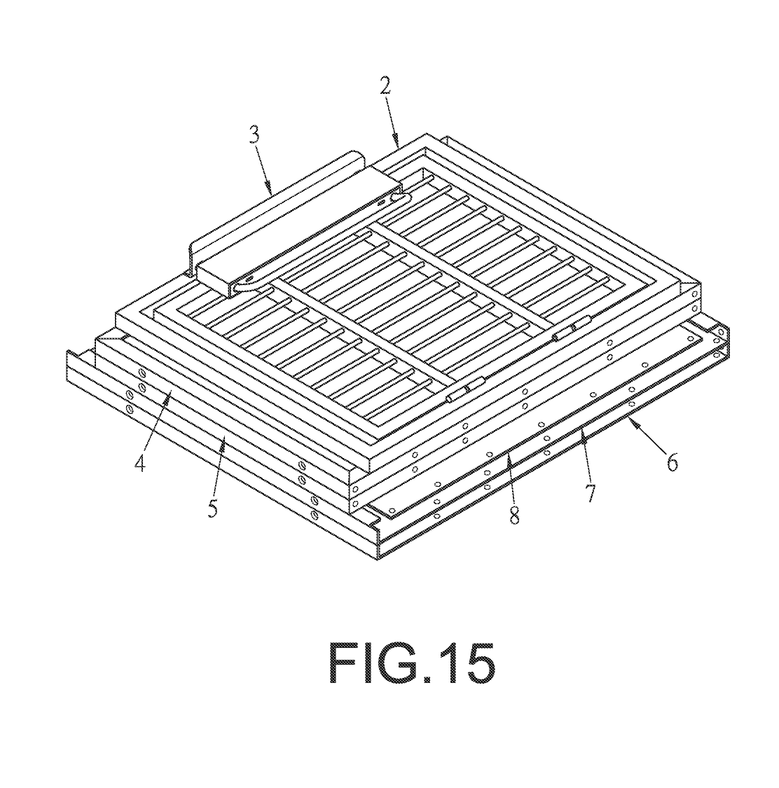

As shown in FIG. 15, all of the parts of the pet cage can be dis-assembled by removing he fasteners 9 and the bolts 64, 74, 81, Therefore, all of the parts can be overlapped piece by piece in order to save the space.

While we have shown and described the embodiment in accordance with the present invention, it should be clear to those skilled in the art that further embodiments may be made without departing from the scope of the present invention.

What is claimed is:

1. A pet cage comprising:
a door frame, a lock unit, a top board, a bottom board, a left board, a right board, a back board and multiple fasteners;
the door frame having multiple holes, a door having a first side thereof pivotally connected to a first side of the door frame by hinges;
the lock unit defined on the second side of the door and a second side of the door frame, the lock unit having a base, a bar, two springs, two pins, a cover, and a receiving base, the base fixed to the door and having two sliding slots respectively defined on the upper and the lower portion of the base, two holes defined respectively at the upper and the lower portion of two sidewalls of the base and corresponding to each other, two engaging slots defined respectively on the two sidewalls of the base and corresponding to each other, the bar having two parallel insertion ends and a grip connected between the two insertion ends, the two insertion ends respectively extending through the holes in the two sidewalls of the base, a pin hole defined respectively on the two insertion ends, the two springs respectively inserted to the two insertion ends and located between the two sidewalls of the base, the two pins respectively extending through the two pin holes of the two insertion ends and respectively approaching to the sliding slot at the upper and the lower portion of the base, one end of the two springs respectively against the inner literal sidewall of the base and the other end of the two springs respectively abutted to the two pins, the cover having two hooks extending from each of two sides thereof, the hooks engaged with the engaging slots of the base to seal the cover to the base, the receiving base fixed on the door frame and its' location corresponding to the location of the base on the door, the receiving base having two apertures which are located corresponding to the holes of the base;
the top board connected to a top side of the door frame, the bottom board connected to a bottom side of the door frame, each of the top board and the bottom board having a wall bending from each of four sides thereof, multiple holes defined through the wall on a front end of each of the top and bottom boards, multiple threaded holes defined through each of the walls on a rear end and two sides of each of the top and bottom boards;
the left board connected to a left side of the door frame, the right board connected to a right side of the door frame, each of the left board and the right board having a wall bending from each of a front end and a rear end thereof, multiple holes defined through the walls on the front end of each of the left and right boards, multiple threaded holes defined through each of the walls on the rear end of each of the left and right boards, multiple holes defined through a top side and a bottom side of each of the left and right boards, each of the holes defined through the top side and the bottom side of each of the left and right boards having a bolt extending therethrough which is threadedly connected to the threaded hole of each of the walls on the rear end and the two sides of each of the top and bottom boards;
the back board connected to rear end of each of the top board, the bottom board, the left board and the right board, the back board having multiple holes and each hole of the back board having a bolt extending therethrough which is threadedly connected to the threaded hole of the top board 4, the bottom board, the left board, and the right board, and
the multiple fasteners securely extending through holes of the door frame, the top board, the bottom board, the left board and the right board.

2. The pet cage as claimed in claim 1, wherein the bar of the lock unit is a U-shaped bar.

3. The pet cage as claimed in claim 1, wherein each of the insertion ends of the bar has an oblique face defined in a distal end thereof.

4. The pet cage as claimed in claim 1, wherein the receiving base has an oblique plate extending from an outside thereof.

5. The pet cage as claimed in claim 1, wherein each of the fasteners has a reception member and a bolt, the reception member has a tubular portion in which a threaded hole is defined, the bolt is threadedly connected to the threaded hole of the tubular portion.
